(19) United States
(12) Patent Application Publication
(10) Pub. No.: US 2022/0287337 A1
(43) Pub. Date: Sep. 15, 2022

(54) Reduced Sugar Juice and Process for Making

(71) Applicant: Welch Foods Inc., A Cooperative, Concord, MA (US)

(72) Inventors: David J. Gomes, Somerville, MA (US); Ricardo Ruiz de Gopegui, Glen Allen, VA (US); David E. McDonald, Framingham, MA (US)

(21) Appl. No.: 17/693,774

(22) Filed: Mar. 14, 2022

Related U.S. Application Data
(60) Provisional application No. 63/161,065, filed on Mar. 15, 2021.

(51) Int. Cl. A23L 2/74; A23L 2/10; B01D 61/14; B01D 69/02

(52) U.S. Cl. CPC A23L 2/74; A23L 2/10; B01D 61/145; B01D 69/02; A23V 2002/00; B01D 2325/20; B01D 2311/06; B01D 2311/08; B01D 2311/2673; B01D 2311/25

(57) ABSTRACT

Reduced sugar juices and methods of producing the reduced sugar juices from single strength juice or juice blends are described.

### RELATED APPLICATION

This application claims the benefit of U.S. Provisional Application No. 63/161,065, filed on Mar. 15, 2021. The entire teachings of the above application(s) are incorporated herein by reference.

### BACKGROUND

There is a demand by consumers for reduced sugar juices that have acceptable taste and sweetness. Consequently, there is a need for methods for making reduced sugar juices for use in downstream food and beverage manufacturing or as reduced sugar juices comprising natural sugars.

### SUMMARY

The present disclosure pertains to reduced sugar juice from single strength juice, juice blends, or reconstituted juice from juice concentrate and to methods for making reduced sugar juice. The reduced sugar juices prepared by the methods of the disclosure have a target reduced sugar content and maintain flavor notes that are characteristic of the starting juice before filtration.

Methods for producing a reduced sugar juice, comprise filtering feed juice (e.g., single strength juice, juice blend, or reconstituted juice from juice concentrate) through a filtration membrane (e.g., ultrafiltration) to produce permeate juice having lower color and sugar content compared to the feed juice, and retentate juice having a color and sugar content being higher than the feed juice; concentrating the permeate juice in an evaporator to produce a concentrated permeate juice fraction and a fraction comprising water and essence; and adding the water and essence fraction to the retentate juice in an amount sufficient to produce a juice having a reduced sugar content compared to the sugar content of the feed juice and having flavor notes that are characteristic of the feed juice before filtration. In an alternative embodiment, the retentate juice is concentrated in an evaporator to produce a concentrated retentate juice fraction and a fraction comprising water and essence; the water and essence fraction is then added to the permeate in an amount sufficient to produce a juice having a reduced sugar content compared to the sugar content of the feed juice and having flavor notes that are characteristic of the feed juice before filtration. In a version of the method, the water and essence are obtained from another juice product stream, rather than from the permeate or retentate fractions, and added to the reduced sugar juice (either the permeate or the retentate depending on the process embodiment) to create a blend of flavors in the final product. In another version, at least a portion of the retentate juice is recycled back through the filtration membrane. In yet another version, at least one surge tank can be placed at different points in the system. For example, a surge tank can receive the permeate juice and build a surge of permeate before concentrating the permeate juice in an evaporator.

Juice can be any fruit juice, vegetable juice or combination thereof, particularly juice from grapes (e.g., Concord or Niagara grapes), apple, cranberry or pomegranate grape juice. In embodiments, reduced sugar juice produced by the process of the disclosure comprises a mixture of the retentate juice and the water and essence separated from the permeate, or a mixture of the permeate juice and the water and essence separated from the retentate. This reduced sugar juice has flavor notes that are characteristic of the starting juice because the juice's characteristic essence has been extracted and added back to the reduced sugar juice. When the grapes are Concord grapes, the essence is methyl anthranilate and/or o-aminoacetophenone. In another embodiment, the reduced sugar juice produced by the process of the disclosure comprises a mixture of the retentate or permeate, depending on the process, cut back water and essence from another juice product stream to create a blend of flavor notes in the final product that are characteristic flavor notes from the juices in the blend.

The permeate is the reduced juice product in an embodiment. In another embodiment, the permeate can be processed through an evaporator to produce a concentrated juice fraction and a fraction comprising water and essence from the juice. The fraction comprising water and essence is added to the retentate in an amount sufficient to produce a juice having a target reduced sugar content and having flavor notes that are characteristic of the starting juice before filtration. Alternatively, the retentate can be processed through an evaporator to produce a concentrated juice fraction and a fraction comprising water and essence from the juice. The fraction comprising water and essence is added to the permeate in an amount sufficient to produce a juice having a target reduced sugar content and having flavor notes that are characteristic of the starting juice before filtration.

In yet another embodiment, a reduced sugar juice produced by methods of the disclosure comprises the permeate fraction from ultrafiltration of the juice and having a sugar content that is reduced, relative to the starting juice, by about 35% to about 70% and a reduced color profile compared to the unfiltered juice, flavor notes that are characteristic of the unfiltered juice and metal ion level (e.g., potassium and calcium) similar to the unfiltered juice.

In a further embodiment, an ultrafiltered juice comprises a reduced sugar content of from about 35% to about 70% of its naturally occurring sugar content, having flavor notes that are characteristic of the juice before ultrafiltration and retains some of the color of the juice before filtration. For example, an ultrafiltered juice can have up to a 70% reduction in sugar content compared to an unfiltered counterpart juice, and at least a 15% reduction in each of color (contributed by its anthocyanins content) and total polyphenols content (percent by weight), such that the ultrafiltered juice resembles the unfiltered juice in appearance.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic of an example embodiment showing a continuous filtration process with the ultrafilter sized appropriately to allow for continuous production of permeate with reduced sugar solids than the feed juice.

FIG. 2 is a schematic showing an alternative embodiment of the process illustrated in FIG. 1, using a filtration process with retentate being recycled to the feed. In operation, a portion of the retentate is returned to feed until the end of the run and then collected in the retentate.

FIG. 3 is a schematic of an example embodiment showing a continuous filtration process with the ultrafilter sized appropriately and configured to produce a continuous flow of permeate to feed into a continuous evaporator.

FIG. 4 is a schematic of an example embodiment showing a continuous filtration process having a surge tank for collecting permeate prior to being feed into an evaporator. A representative surge tank is shown for illustration purposes. It is noted that one or a plurality of surge tanks could fit anywhere in the system where there are lines between products and pieces of equipment. The number and placement of surge tanks will depend on system design and process scale.

FIG. 5 is a schematic of an example embodiment showing a filtration process configured to continuously feed permeate to an evaporator and to recycle retentate to the feed. In operation, a portion of the retentate is returned to feed until the end of the run, and the permeate is processed directly to the evaporator. Surge tanks, holding tanks or recycling tanks (not shown) would be used in the system, as appropriate.

FIG. 6 is a schematic of an example embodiment showing a continuous filtration process with the ultrafilter sized appropriately and configured to produce a continuous flow of retentate to feed into a continuous evaporator. Water and essence can be added to permeate to produce a reduced sugar juice. Surge tanks, holding tanks or recycling tanks (not shown) would be used in the system, as appropriate.

FIG. 7 is a schematic of an example embodiment showing a filtration process configured to continuously feed retentate to an evaporator and to recycle retentate to the feed. In operation, a portion of the retentate is returned to feed until the end of the run, and the retentate is processed directly to the evaporator. Water and essence can be added to permeate to produce a reduced sugar juice. Surge tanks, holding tanks or recycling tanks (not shown) would be used in the system, as appropriate.

### DETAILED DESCRIPTION

A description of example embodiments follows.

### Definitions

As used herein, singular articles such as “a,” “an” and “the,” and similar referents are to be construed to cover both the singular and the plural, unless otherwise indicated herein or clearly contradicted by context.

“About” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of ±20%, ±10%, ±5% or ±1% of a given value. It is to be understood that the term “about” can precede any particular value specified herein, except for particular values used in the Exemplification.

Reduced sugar juice is defined herein to mean a juice that has been processed to reduce the level of one or more naturally occurring sugars in the feed juice. The reduction in sugar content is an amount that is relative to the starting juice, such as a percent sugar reduction as determined by Brix. The sugar content of the final juice can be reduced, relative to the starting juice, to from about 35% to about 70% Brix. Sugar reduction can be at least 35%, at least 50%, at least 60%, at least 70%, for example, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70% Brix, or about % Brix of any of these. A reduced sugar juice produced according to the methods described herein should be understood to include, but not limited to, an ultrafiltered juice, a reduced sugar beverage, a reduce sugar cocktail, or other term understood in the industry for a product obtained from fruit and/or vegetable juice but not necessarily comprising all of the sugar compared to the unfiltered starting juice.

Essence is defined herein to mean a component, such as a volatile or aromatic component, naturally present in the juice that imparts one or more characteristic or unique flavor notes of the juice. In the case of grapes, the essence can be specific for a grape variety, for example, a varietal-specific essence. An example of this is the characteristic flavor notes in Concord grape juice, provided by methyl anthranilate (MA) and o-aminoacetophenone (o-AAP). Volatile components can vary depending upon harvest and growing conditions.

Flavor note(s) is intended to mean the aroma and/or taste of juice due to the presence of a volatile or aromatic component (essence) that contributes to the characteristic flavor of the juice. The flavor notes do not include the flavor imparted to the juice from its sugar solids content. The reduced sugar juice of the disclosure retains the flavor notes that are characteristic of the juice before the ultrafiltration process. In some embodiments, the flavor notes can be reduced in the reduced sugar juice compared to the unfiltered starting juice but the objective is to retain as much of the flavor notes as possible. In other embodiments, the flavor notes can be augmented by the addition of essence from other juice streams into the reduced juice products of the disclosure. For example, flavor notes in Concord Grape include but are not limited to MA, o-AAP. In some embodiments, the essence is comprised of volatile compounds from the starting juice that are added back to the permeate or the retentate, depending upon the process selected. In other embodiments, essence is comprised of volatile compounds or a specific volatile compound from another fruit or vegetable source can be added to the permeate or retentate to augment the flavors of the reduced sugar juice.

Cutback is defined herein to mean reducing the sugar levels in a juice concentrate, such as dilution by the addition of water (also referred to as cutback water) or water comprising essence. The degree of cutback of the final juice product can be determined by the desired Brix. Methods for determining the sugar content are well-known.

Brix is defined herein to mean the value on the Brix scale representing the amount of dissolved sugar solids in a liquid via its specific gravity. One-degree brix is equivalent to 1 gram of sucrose in 100 mL of water. Brix can be measured by a number of different ways, including but not limited to, brix meter, refractometer, digital density meter, hydrometer and pycnometer. Brix can be expressed a number of ways, such as but not limited to degree Brix, ° Brix, Brix, % Brix, BX, % BX, ° BX.

Permeate is defined herein to be the fraction of juice that passes through the filter.

Retentate is defined herein to be the fraction of juice that cannot pass through the pores of the filter.

Single strength juice is defined herein to mean 100% juice that is reconstituted from a concentrate by dilution with water to the natural (i.e. pre-concentration) single-strength Brix or to a Brix that meets 100% juice definition as defined in 21 CFR 101.30 for the Unites States, but other jurisdiction may have different regulatory requirements and definitions for 100% juice and they are intended to be covered herein.

Not from concentrate (NFC) juice is defined herein to mean juice products that are obtained by pressing fruit, separating from pulp and debris to the required level and that has not been concentrated.

Juice concentrate, for the purposes of this disclosure, is defined herein to mean a juice from a product stream from the methods disclosed herein that is concentrated, for example, by evaporation. For example, the final Brix of the concentrate can be from about 45 Brix to about 68 Brix.

A reconstituted juice concentrate, for the purposes of this disclosure, is defined herein to mean, in the context of a starting juice, a concentrated juice that is diluted with water to a level that is not the natural strength Brix.

Juice blend is defined herein to mean two or more different fruit juices, vegetable juices, or combinations thereof. When a juice blend is used as the starting juice in the methods of the disclosure, the juice blends are single-strength juices, as defined above, that are blended together. The juice blend can also be the product of the methods of the disclosure, where the product comprises a reduced sugar juice from two or more different fruit juices, vegetable juices, or combinations thereof. The final reduced sugar juice blend product is not diluted.

Dilution and undiluted as used herein are intended to define the treatment of the juice before it is passed through the ultrafiltration membrane, and the treatment of the reduced juice products collected after ultrafiltration. It should be understood that the NFC juices are not diluted prior to the ultrafiltration process. For a juice product collected after ultrafiltration, the product, whether it is a ready to serve (RTS) juice or ready to drink (RTD) juice, or a downstream food or beverage ingredient, is not diluted (undiluted). However, the final reduced sugar juice can be concentrated and subsequently reconstituted.

The subject disclosure pertains to reduced sugar juices and methods of producing the reduced sugar juices from single strength juice, juice blends or juice concentrates. For example, a single strength grape juice will have a natural sugar solids content of from about 10 Brix to about 29 Brix. In a preferred embodiment, the single strength juice will have a Brix value of about 16 Brix for grapes, about 11.5 for apple, about 12.0 for pomegranate, about 8.0 for red raspberry and about 11.1 for black raspberry.

Ultrafiltration is used in the methods of the disclosure to separate single strength juice, juice blends or reconstituted juice from concentrate into a permeate fraction and a retentate fraction. In an embodiment of the method, the feed juice need only pass through the ultrafiltration membrane once. In another embodiment, the retentate can be recirculated to the feed vessel and processed through the membrane filter to continuously remove permeate from the juice feed until a desired endpoint is reached. For example, the filtration endpoint can be when the desired sugar solids are reached in the permeate or when there is no longer sufficient permeate being removed through the membrane.

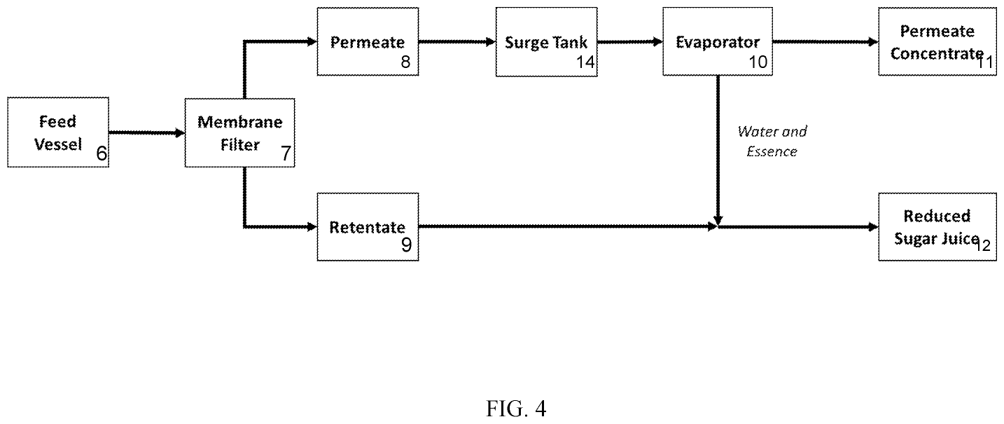

As is common in beverage manufacturing there may be surge tanks used throughout the processes to aid in creating an efficient process. One or a plurality of surge tanks could fit anywhere in the system, such as any of the embodiments illustrated in the figures, where there are lines between products or pieces of equipment. The number and placement of surge tanks will depend on system design and process scale. Surge tanks can be interchangeably referred to as holding tanks or feed tanks. A surge tank, illustrated in FIG. 4, is positioned to receive the permeate juice and builds a surge of permeate before concentrating the permeate juice in an evaporator.

A suitable ultrafiltration membrane for use in the processes of the disclosure is one that will separate the juice into a permeate fraction and a retentate fraction, allowing the majority of sugars to be retained in the retentate fraction. The membrane can be a flat sheet membrane or a spiral wound membrane. Preferably, the filtration method is tangential flow filtration (TFF). The molecular weight cutoff (MWCO) of the ultrafiltration membranes can be from about 500 Daltons (Da) to about 30,000 Da (500 Da, 1,000 Da, 2,000 Da, 3,000 Da, 5,000 Da, 10,000 Da, 20,000 Da, 30,000 Da), with 20,000 Da being preferred. It is understood that the MWCO is selected to retain the sugars in the retentate fraction. For example, sucrose, glucose and fructose will pass through to the permeate fraction. After filtration, the sugar concentration in the permeate fraction should be reduced to from about 35% to about 70%, compared to the sugar concentration in the juice before ultrafiltration. The skilled person will be able to readily ascertain the types of membranes, their materials and the membrane area (e.g., food grade membranes) that can be used in the methods of the disclosure. Suitable membranes for use in the processes of the disclosure are comprised of polyethersulfone, polysulfone, polyamide thin film composites, cellulose acetate, polyvinylidene fluoride (PVDF), polyacrylonitrile (PAN).

The operating parameters of the filtration process will be determined by the ultrafiltration membrane selected and these parameters can be readily ascertained by the skilled person and are determinant upon the type/degree of separation to be achieved. The operating pressure is preferably from about 50 psi to about 500 psi depending on the membrane type. Flow rate of the juice through the membranes will vary depending on membrane type and scale of the filtration process. The flow rate is determined by membrane type, recommendations given by vendors and flow rate varied to optimize membrane flux and minimize membrane fouling. Processing temperature will be known to the skilled person and can be determined by the type of fruit, vegetable or mixture of fruits and/or vegetables that is to be filtered using the methods described herein. Generally, a suitable temperature will range from about 40° F. to about 100° F. (about 4° C. to about 38° C.). The permeate flux can be readily ascertained by the skilled person considering permeate flow rate and membrane surface area factors. The time run can be readily ascertained by the skilled person based on the volume of permeate that needs to be collected to achieve a desired percent reduction in sugar levels. As an example, to achieve a 50% sugar reduction, it is desirable to remove about 60% of the volume of feed as permeate to remove enough sugar so that the combination of water, essence, and retentate equals 50% of the starting sugar. The run time is dictated by the 1) starting feed volume, 2) desired sugar reduction, and 3) Brix of the permeate and retentate streams. The higher the Brix of the permeate, the less volume needs to be removed in order to achieve a sugar reduction in the retentate, water, and essence combination.

### Reduced Sugar Juice

The reduced sugar juice produced by the methods of the disclosure can be used in downstream food and beverage manufacturing or as reduced sugar juices comprising natural sugars. In one embodiment, reduced sugar juice comprises a mixture of the retentate from the juice filtration process and water and essence from the permeate and has flavor notes that are characteristic of the starting juice. In another embodiment, reduced sugar juice comprises a mixture of the permeate from the juice filtration process and water and essence extracted from the retentate and has flavor notes that are characteristic of the starting juice. The juice product can have a sugar content that is reduced by at least about 35% to about 70%, compared to the starting juice. In another embodiment, a reduced sugar juice comprises the permeate fraction from the ultrafiltration process and has a sugar content that is reduced by at least about 35% to about 70% by weight of sugar solids, compared to the starting juice. In yet another embodiment, reduced sugar juice comprises a mixture of the retentate or permeate (depending up the system embodiment) from the juice filtration process, cutback water, and essence from another juice product stream to create a reduced sugar juice having a blend of flavor notes that are characteristic of the starting juice and that provided by the essence of the other juice product stream.

Products from the filtration processes described herein can be used as ingredients in downstream food and beverage manufacturing. Examples of uses for reduced sugar juice include, but are not limited to, neutral bases and filler juice for producing blended jellies, jams, juices, sparkling juices, preserves or other fruit spreads, juice drinks, wine, spirits and fruit flavored waters and liquors. When undiluted retentate juice is used as an ingredient in downstream food and beverage manufacturing, it can be used as sweeteners, sugars replacers and coloring agents due to the higher sugar and color content, compared to the starting juice.

Prior to performing the ultrafiltration methods of the disclosure, the fruit or vegetable will need to be prepared by pressing the fruit or vegetable to produce juice, separating/filtering the juice from pulp and debris to the required level and clarifying the juice. Examples of fruit juices that can be used in the methods of the disclosure include but are not limited to apple, grape, cranberry, pomegranate, pear, peach, pineapple, cherry, melon (watermelon, cantaloupe), watermelon, prune, plum, kiwi, avocado, mango, banana, papaya, apricot, acai, tomato; citrus fruits including but not limited to lemon, orange, grapefruit and lime; and berries including but not limited to strawberry, blackberry, boysenberry, raspberry, blueberry, currants. The juice can be obtained from the fruit directly or reconstituted from concentrated juice prior to use in the methods of the disclosure. The final reduced sugar juice can be a single fruit or vegetable juice or it can be a blend of fruit and/or vegetable juices. In some embodiments, the reduced sugar juice can be blended with vegetable juices such as, but not limited to, cucumber, beet, carrot, pepper, zucchini, squash, eggplant, pumpkin.

In embodiments, the fruit juice is grape juice that yields purple or white juice. Any grape variety, such as Concord and Niagara grapes, can be used as they yield juice for beverages and can be incorporated into other food products.

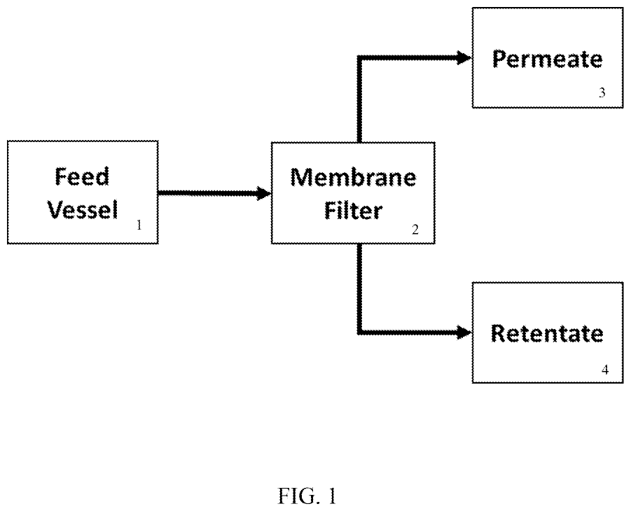

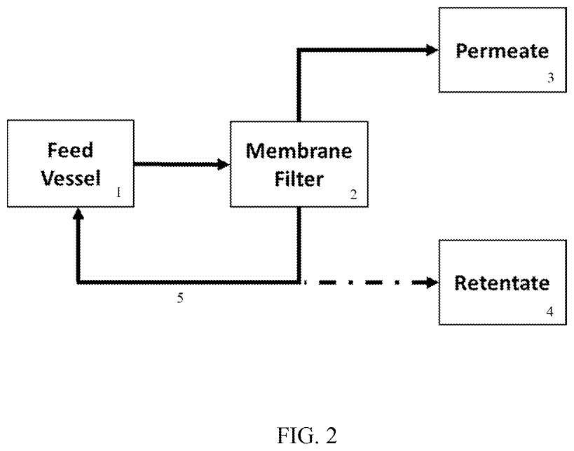

In one embodiment, the reduced sugar juice will be the permeate fraction from the filtration of Concord grape juice and will have a light pink color and some flavor notes that are characteristic of Concord grapes. The dark color that is characteristic of Concord grape juice will be in the retentate fraction from the ultrafiltration and this can be further used in as ingredients in downstream food and beverage manufacturing. See FIGS. 1 and 2, without and with recycling of the feed.

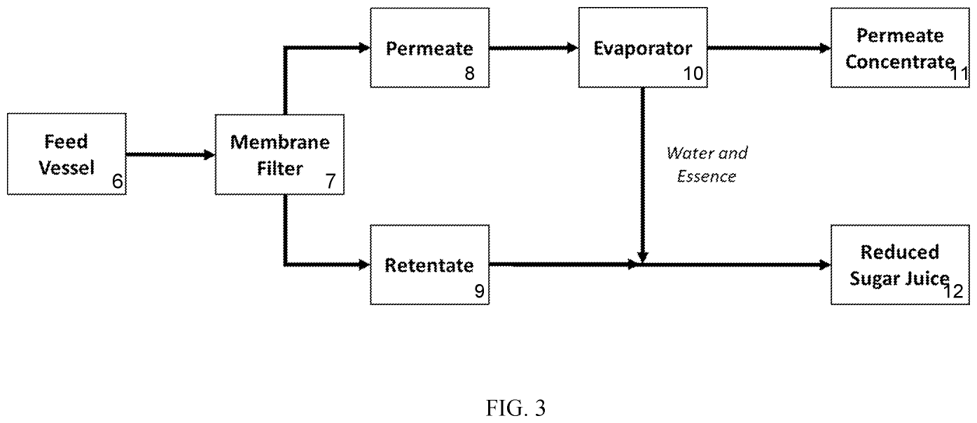

In another embodiment, as illustrated in FIG. 3, the reduced sugar juice will be the retentate fraction from the filtration of Concord grape juice, with a combination of essence and water extracted from the permeate added as cutback to the retentate fraction. The juice will be reduced in sugar solids content to a desired level depending upon the degree of cutback. In one version of this embodiment, the reduced sugar juice will have the characteristic color and appearance of full-strength Concord grape juice and will still contain some nutrients of the full-strength juice but with approximately half the sugar content of Concord grapes. In preferred embodiments, the final juice will have a reduction in sugar solids of from about 35% to about 70%, compared to the Concord grape juice prior to filtration. Essence recovered from the permeate will comprise flavor notes that are characteristic of Concord grapes, including but not limited to methyl anthranilate (MA) and o-aminoacetophenone (o-AAP).

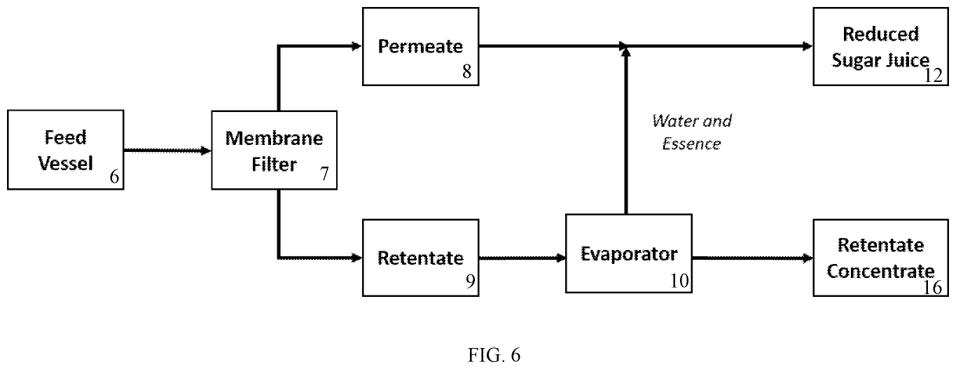

In yet another embodiment, as illustrated in FIG. 6, the reduced sugar juice will be the permeate fraction from the filtration of Concord grape juice, with a combination of essence and water extracted from the retentate added as cutback to the permeate fraction. The juice will be reduced in sugar solids content to a desired level depending upon the degree of cutback. In one version of this embodiment, the reduced sugar juice will have a light pink color and flavor notes that are characteristic of Concord grapes but with approximately half the sugar content of Concord grapes. In preferred embodiments, the final juice will have a reduction in sugar solids of from about 35% to about 70%, compared to the Concord grape juice prior to filtration. Essence recovered from the retentate will comprise flavor notes that are characteristic of Concord grapes, including but not limited to methyl anthranilate (MA) and o-aminoacetophenone (o-AAP).

In another example embodiment, the reduced sugar juice will be the retentate fraction from the filtration of Niagara grape juice and comprising a combination of essence and water extracted from the permeate which is added as cutback to the retentate fraction. This will yield a reduced sugar Niagara grape juice with the characteristic color and flavor notes compared to the full-strength juice before processing but with a fraction of the natural sugars. Alternatively, the reduced sugar juice will be the permeate fraction from the filtration of Niagara grape juice and comprising a combination of essence and water extracted from the retentate which is added as cutback to the permeate fraction. This will yield a reduced sugar Niagara grape juice with the characteristic flavor notes compared to the full-strength juice before processing but with a lighter color and a fraction of the natural sugars. In preferred embodiments, the final juice will have a reduction in sugar solids of from about 35% to about 70% compared to the juice prior to filtration. Essence recovered from the permeate or the retentate, depending on the process, will comprise flavor notes that are characteristic of Niagara grapes.

In other embodiments, cutback water and essence does not necessarily need to be obtained from the permeate or retentate juice fraction, depending upon the system embodiment. It can be obtained from other juices and added to the permeate or retentate juice, depending upon the process, to create a blended flavor profile.

Methodologies for determining volatiles are provided in Perry, D. M.; Hayes, J. E., Effects of Matrix Composition on Detection Threshold Estimates for Methyl Anthranilate and 2-Aminoacetophenone. Foods, 5, 35 (2016); Perry, D. M, et al., Rejection of Labrusca-Type Aromas in Wine Differs by Wine Expertise and Geographic Region. Food Quality and Preference, Volume 74, 147-154 (2019), the entire teachings of which are incorporated herein by reference.

The flavor notes can be ascertained by organoleptic determination, or by analytical methods. The color profile can be evaluated by Spectrophotometer Absorbance measurement (for instance using a Konica-Minolta CM-600 Spectrophotometer as a non-limiting example), comparing initial feed juice (starting juice) and reduced sugar juice. For ultrafiltered juice from the permeate, the color will be reduced compared to the starting unfiltered juice. The degree of color reduction will be from about 80% to about 90%. For ultrafiltered juice that is produced from the retentate fraction, water and essence (from the permeate fraction), the color of the ultrafiltered juice resembles the unfiltered juice in appearance with about 15% to about 30% reduction in color. For ultrafiltered juice that is produced from the permeate fraction, water and essence (from the retentate fraction), the color of the ultrafiltered juice is much lighter than the unfiltered juice in appearance with about 80% to about 90% reduction in color.

### Methods

Methods described herein can be performed in batch, semi-batch or continuous/in-line mode. For illustration purposes, the methods described herein illustrate the use of Concord grape juice as an example embodiment. It should be understood that the methods can be varied for other fruit juices and vegetable juices by the skilled person in view of the teachings herein, for example, by adjusting the membrane cut-off size to remove desired sugar in the juice. It is noted that juices such as grape, cranberry, apple, pear and peach will be able to use the same membranes because the types of sugar to be removed are similar. The concentration of sugars in each juice may be different but the types of sugar are the same and can pass through the ultrafiltration members to the same extent. In example embodiments, Concord grapes, Niagara grapes, apple, pomegranate and cranberry were processed according to the methods of the disclosure using the same MWCO membrane and a 50% sugar reduction was achieved. The sugar content can be reduced to about 7° Brix to about 10° Brix for Concord juice, about 5° Brix to about 7° Brix for apple juice, from about 3° Brix to about 4° Brix for cranberry juice, from about 7° Brix to about 9° Brix for pomegranate juice, compared to the sugar content of the full-strength fruit juice or vegetable juice.

According to one embodiment, a method for producing reduced sugar grape juice comprises, filtering grape juice, such as Concord grape juice or labrusca varieties or hybrid varieties, through an ultrafiltration membrane under conditions (temperature, pressure, flow rate), to produce permeate comprising a juice fraction that is low in color and having a reduced sugar content compared to the starting juice, and retentate comprising a juice fraction that is higher in color compared to the starting juice and higher in sugar content compared to the starting juice. In one embodiment, the permeate is collected as the reduced sugar juice product (see FIG. 1 and FIG. 2, without and with recirculation of the retentate back to the feed). In another embodiment, the retentate is collected as a product or ingredient for use in other food and beverage product streams. In yet another embodiment, water and optional fruit juice or vegetable juice essence from the same or different fruit or vegetable source is added to the retentate juice fraction in an amount sufficient to produce a fruit juice or vegetable juice having a reduced sugar content compared to the sugar content of the feed juice and having flavor notes that are characteristic of the feed juice before ultrafiltration and flavor notes from the optional essence if added.

FIG. 1 shows a schematic of an example embodiment of a process for reducing the sugar content in a feed juice. Juice feed vessel 1 houses juice (e.g., single strength juice, juice blends, or reconstituted juice from juice concentrate), for example, after the fruit has been harvested and crushed. From the juice feed vessel 1, the juice is passed through a membrane filter 2 that is appropriately sized to allow for continuous filtration of the juice into a permeate fraction 3 that is low in color (compared to the starting juice color) and having a reduced sugar solids content (at least about 35% to about 70% lower than the starting juice), and a retentate fraction 4 that is higher in color (compared to the feed juice) and having a higher sugar solids content (compared to the starting juice). The membrane filter is appropriately sized to achieve a reduction in sugar solids content of the permeate to at least about 35% to about 70% lower than the starting feed juice and to allow the remaining sugars to be retained in the retentate fraction. The retentate fraction can be stored and used in other product streams, such as a high color ingredient, sweetener, it can be concentrated or used for isolating ingredients in the retentate fraction.

The molecular cut-off weight (MWCO) useful for the embodiment illustrated in FIG. 1, will be selected to permit continuous processing of the feed juice, while allowing for the sugars to be retained by the membrane (retentate fraction). In embodiments, the filter membrane (e.g., polyamide thin film composite membrane) MWCO is less than about 5,000 Da, from about 600 Da to about 5,000 Da, from about 800 Da to about 3,000 Da, from about 1,000 Da to about 5,000 Da.

The permeate can be processed and packaged for consumer use or it can be further processed as an ingredient in other products to produce products with reduced sugar content compared to similar products that do not contain the reduced sugar juice. The retentate can be used directly in other product streams or concentrated, stored and reconstituted when used.

Alternatively, the filtration process illustrated in FIG. 1 can be performed in batches using an appropriately sized filtration membrane, such as a 1,000 Da membrane.

When Concord grape juice is used as the juice feed in the process of FIG. 1, the permeate will be light pink in color with some of the flavor notes that are characteristic of Concord grapes. The sugar content can be reduced by at least about 50%. For example, the feed juice can have a sugar content of 15.7 Brix and the permeate can have a sugar content of 8.25-8.5 Brix using a 1,000 Da filtration membrane.

FIG. 2 is an alternative embodiment to the process illustrated in FIG. 1. FIG. 2 shows a schematic of an example embodiment of a filtration process for reducing the sugar content in a feed juice with a retentate to feed vessel recycle feature. Juice feed vessel 1 houses feed juice (e.g., single strength juice, juice blends or reconstituted juice from juice concentrate), for example, after the fruit has been harvested and crushed, and juice from the retentate fraction. From the juice feed vessel 1, the juice is passed through a membrane filter 2 that is appropriately sized to allow for continuous filtration of the juice into a permeate fraction 3 that is low in color (compared to the starting juice color) and having a reduced sugar solids content (at least about 35% to about 70% lower than the starting juice), and a retentate fraction 4 that is higher in color (compared to the feed juice) and having a higher sugar content (compared to the starting juice). All or a fraction of the retentate can be recycled back to the juice feed vessel 1 using a recirculation loop 5 and further processed through the membrane filter 2 for a period of time sufficient to achieve a desired endpoint (e.g., end of the run). For example, a desired endpoint can be determined by a desired level of sugar in the permeate fraction, such as achieving a reduction of sugar solids to at least about 35% to about 70% relative to the starting juice. The endpoint can also be determined when permeate collection has slowed or stopped. As an example, when the sugars in the retentate continue to be concentrated by the recirculation process, the sugars in the permeate also increase. Separating up to 15% of the volume as permeate results in a permeate juice with 50% lower sugar. Beyond this level, lower sugar reduction of the resulting permeate juice can be achieved.

Once the process illustrated in FIG. 2 is completed, any remaining juice in feed vessel 1 is combined with the retentate to produce a composite juice that can be stored, further processed or incorporated into other process streams or products. The resulting permeate and retentate fractions can be processed as described above for FIG. 1.

FIG. 3 shows a schematic of an example embodiment of a process for reducing the sugar content in a feed juice. Juice feed vessel 6 houses juice (e.g., single strength juice, juice blends, reconstituted juice from juice concentrate), for example, after the fruit has been harvested and crushed. From the juice feed vessel 6, the juice is passed through a membrane filter 7 that is appropriately sized to allow for continuous filtration of the juice into a permeate fraction 8 that is low in color (compared to the starting juice color) and having a reduced sugar solids content (at least about 35% to about 70% lower than the starting juice), and a retentate fraction 9 that is higher in color (compared to the feed juice) and having a higher sugar content (compared to the starting juice). The permeate fraction is continuously feed into evaporator 10, where water and essence are removed from the permeate and returned to the retentate stream as cutback to produce a reduced sugar juice 12. The resulting permeate is concentrated and stored as permeate concentrate 11.

The level of sugar solids in the retentate juice fraction is cut back using the essence and water from the evaporator, to a desired level to produce a juice product that is reduced in sugar content compared to the starting juice. The addition of essence back into the retentate will yield a reduced sugar juice that has a flavor profile that is comparable to the starting fruit juice before filtration.

Essence and water is added to the retentate juice fraction by mixing (not shown). Mixing may occur either in-line or via mixing tanks. In-line mixing would be the non-concentrated stream immediately being mixed with the water and essence from the evaporation process of the other filter product stream. Batch mixing would involve surge tanks to hold the non-concentrated filter stream and the water/essence from the evaporation process. These would then be mixed as necessary in mixing vessels before further processing.

The permeate juice fraction is concentrated using an evaporator under conditions and for a period of time sufficient to remove essence (flavors and volatiles) and water which is collected as cut back. For example, concentration can be performed using an evaporator with a volatiles recovery unit at a temperature of from about 100° F. to about 212° F., and vacuum of from about 10 psig to full vacuum (about 0 psig) (APV Evaporator Handbook, Fourth Edition, the teachings of which are incorporated herein in their entirety).

The permeate concentrate resulting from the process as illustrated in FIG. 3 is low in color, compared to the starting juice, and can be collected for use as ingredients in other product streams. When the juice is concentrated in this manner, the sugar solids will be increased to a desired level. For example, the sugar solids in the concentrated permeate will be from about 45 Brix to about 68 Brix. In a preferred embodiment, the juice concentrate will be about 57 Brix to about 68 Brix.

When Concord grape juice is used as the juice feed in the process of FIG. 3, the mixture of retentate, water and essence (from the permeate fraction) will yield a reduced sugar purple juice with flavor notes that are characteristic of Concord grapes, but having approximately half of the sugar content of the starting Concord grape juice. In one example embodiment, the feed juice can have a sugar content of 15.1° Brix and the reduce juice product can have a sugar content of 7.6° Brix using a 20,000 Da filtration membrane. In another example embodiment, the feed juice can have a sugar content of 16.9° Brix and the reduce juice product can have a sugar content of 8.2° Brix using a 20,000 Da filtration membrane.

In embodiments, the filter membrane (e.g., polyethersulfone or polysulfone) MWCO is above about 5,000 Da, more specifically a membrane of about 10,000 Da to about 20,000 Da.

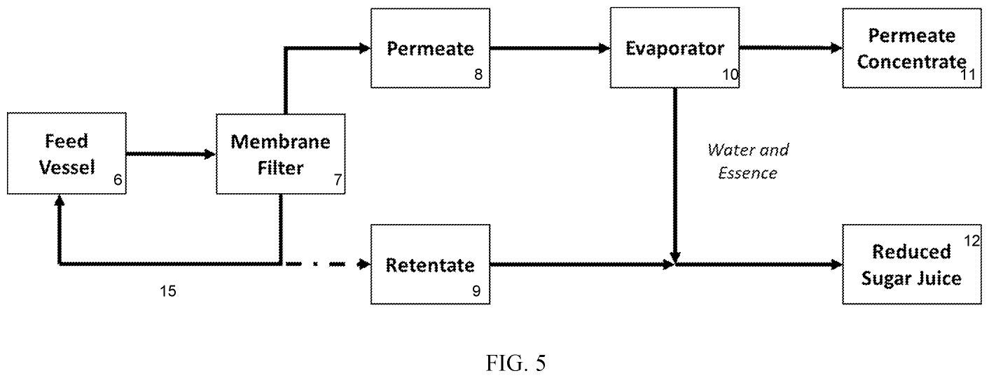

Example embodiments and variations of the method of FIG. 3 are illustrated in FIGS. 4 and 5, including the use of a surge tank 14 and a retentate to feed vessel recycle feature, and combination of surge tank 14 and recycle feature. Unless otherwise described, the features in common among FIGS. 3-5 are as described in FIG. 3. As stated above, the surge tank 14 is shown for illustration purposes in FIG. 4 but the skilled person can use one or a plurality of surge tanks, holding tanks or feed tanks anywhere in the system where there are lines between products and pieces of equipment. The number and placement of surge tanks will depend on system design and process scale.

FIG. 4 is a schematic illustrating an alternative embodiment of FIG. 3 for the continuous filtration process for reducing the sugar content in a feed juice that includes a surge tank feature. A surge tank 14 is positioned between permeate 8 and evaporator 10 and houses permeate before processing through evaporator 10. As the feed juice continuously passes through filter member 7, the permeate is held in surge tank 14 until a sufficient volume of permeate is collected, then it is processed through evaporator 10. The remainder of the process follows as described above for FIG. 3.

FIG. 5 is a schematic illustrating an alternative embodiment of FIG. 3 for the continuous filtration process for reducing the sugar content in a feed juice that includes a retentate to feed vessel recycle feature. All or a fraction of the retentate can be recycled back to the juice feed vessel 6 using a recirculation loop 15 and further processed through the membrane filter 7 for a period of time sufficient to achieve a desired endpoint. For example, a desired endpoint can be determined by a desired level of sugar solids in the retentate fraction, such as achieving a reduction of sugar solids to at least about 35% to about 70% compared to the starting juice. The endpoint can also be determined when permeate collection has slowed or stopped. The resulting permeate concentrate can be processed as described above.

Once the process is completed, any remaining juice in the feed vessel 6 is combined with the retentate to produce a composite juice. Water and essence from evaporator 10 are added to the composite juice in an amount sufficient to produce the reduced sugar juice with desired reduction in sugar content. Preferably, all of the water and essence recovered in the evaporation process is added to the retentate juice to achieve a maximum sugar reduction of the retentate juice.

FIG. 6 shows a schematic of an example embodiment of a process for reducing the sugar content in a feed juice. Juice feed vessel 6 houses juice (e.g., single strength juice, juice blends, reconstituted juice from juice concentrate), for example, after the fruit has been harvested and crushed. From the juice feed vessel 6, the juice is passed through a membrane filter 7 that is appropriately sized to allow for continuous filtration of the juice into a permeate fraction 8 that is low in color (compared to the starting juice color) and having a reduced sugar solids content (at least about 35% to about 70% lower than the starting juice), and a retentate fraction 9 that is higher in color (compared to the feed juice) and having a higher sugar content (compared to the starting juice). The retentate fraction is continuously feed into evaporator 10, where water and essence are removed from the retentate and returned to the permeate stream as cutback to produce a reduced sugar juice 12. The resulting retentate is concentrated and stored as retentate concentrate 16 and can be used as a high color ingredient in other product streams.

The level of sugar solids in the permeate juice fraction is cut back using the essence and water from the retentate fraction (by mixing as discussed above), to a desired level to produce a juice product that is reduced in sugar content compared to the starting juice. The addition of essence back into the permeate will yield a reduced sugar juice that has a flavor profile that is comparable to the starting fruit juice before filtration, but will be less astringent than the starting juice.

The retentate juice fraction is concentrated using an evaporator under conditions and for a period of time sufficient to remove essence (flavors and volatiles) and water which is collected as cut back. For example, concentration can be performed using an evaporator with a volatiles recovery unit at a temperature of from about 100° F. to about 212° F., and vacuum of from about 10 psig to full vacuum (about 0 psig) (APV Evaporator Handbook, Fourth Edition, the teachings of which are incorporated herein in their entirety).

The reduced sugar juice 12 resulting from the process as illustrated in FIG. 6 is low in color, compared to the starting juice, and can be collected for use in other product streams or used as reduce sugar juice. The sugar solids in the reduced sugar juice will be reduced to at least about 35% to about 70% relative to the starting juice.

The retentate concentrate 16 resulting from the process as illustrated in FIG. 6, will have a color that is characteristic of the starting juice. When the juice is concentrated in this manner, the sugar solids will be increased to a desired level. For example, the sugar solids in the concentrated retentate will be from about 45 Brix to about 68 Brix. In a preferred embodiment, the juice concentrate will be about 57 Brix to about 68 Brix.

When Concord grape juice is used as the juice feed in the process of FIG. 6, the mixture of permeate, water and essence (from the retentate fraction) will yield a reduced sugar juice that is light pink in color with flavor notes that are characteristic of Concord grapes, but having approximately half of the sugar content of the starting Concord grape juice. In one example embodiment, the feed juice can have a sugar content of 15.1° Brix and the reduce juice product can have a sugar content of 7.6° Brix using a 20,000 Da filtration membrane. In another example embodiment, the feed juice can have a sugar content of 16.9° Brix and the reduce juice product can have a sugar content of 8.2° Brix using a 20,000 Da filtration membrane.

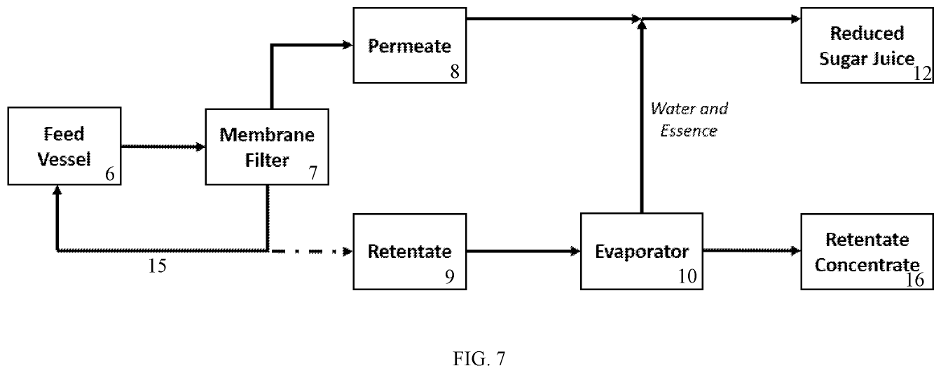

FIG. 7 is a schematic illustrating an alternative embodiment of FIG. 5 for the continuous filtration process for reducing the sugar content in a feed juice that includes a retentate to feed vessel recycle feature. All or a fraction of the retentate can be recycled back to the juice feed vessel 6 using a recirculation loop 15 and further processed through the membrane filter 7 for a period of time sufficient to achieve a desired endpoint. For example, a desired endpoint can be determined by a desired level of sugar solids in the permeate fraction, such as achieving a reduction of sugar solids to at least about 35% to about 70% compared to the starting juice. The endpoint can also be determined when permeate collection has slowed or stopped. The resulting retentate concentrate can be processed as described above.

Once the process is completed, any remaining juice in the feed vessel 6 is combined with the retentate to produce a composite juice. Water and essence from evaporator 10 are added to the composite juice in an amount sufficient to produce the reduced sugar juice with desired reduction in sugar content. Preferably, all of the water and essence recovered in the evaporation process is added to the permeate juice to achieve a maximum sugar reduction of the retentate juice.

The reduced sugar juice is sampled for color and organoleptically evaluated for taste. The presence of volatile components can also be evaluated by GS-MS quantification, including but not limited, to MA and/or o-AAP, if the juice is Concord grape juice. The presence of nutrients and metal ions, such as potassium and calcium, in the final reduced sugar juice can be determined.

An evaporator device with a volatiles recovery unit useful in the present disclosure will be able to reduce the water content of the permeate under vacuum and elevated temperature while at the same time permitting the volatiles components of the permeate to evaporate and be recovered from the system. A preferred concentrator is the APV concentrator, a plate and frame evaporator available from SPX Flow, Inc. Other evaporators can be used in the methods of the present disclosure.

### Examples 1 and 2

### Materials and System Design

System design set up—refer to FIGS. 1 and 2, respectively.
Starting Juice—Reconstituted Concord Grape Juice Concentrate produced from Crop 2021 NFC Concord Grape Juice
Membrane—GE-Series, Thin Film Membrane (Suez Water Technologies) 1,000 Da MWCO Spiral Wound Membrane, 2540 format
Operating Pressure (psi)—350-450

### Operating Temperature (° F.)—50-90

### Experimental Description

The membrane was loaded into the appropriate membrane housing on the filtration unit. Typical clean procedures were followed to ensure proper separation and flux during operation. Once the unit was prepared, about 10 gallons of reconstituted Concord Grape juice was added to the feed tank. This juice was recirculated under pressure to the membrane and back to the feed tank. Permeate was recycled to the feed tank until steady state was reached (about 10 minutes). After steady state had been reached, the permeate was collected in a separate vessel until about 2 gallons had been collected (about 20% of the starting volume). The resulting permeate was a juice containing about 50% reduced sugar content versus the original feed juice.

Feed juice, retentate and permeate streams were characterized analytically and the results presented in Tables 1-4, samples A1-A3.

### Examples 3 and 4

### Materials and System Design

System design set up—refer to FIGS. 3 and 5, respectively.
Starting Juice—Reconstituted Concord Grape Juice Concentrate produced from Crop 2021 NFC Concord Grape Juice
Membrane—P-Series, polyethersulfone (Suez Water Technologies), 20,000 Da MWCO Spiral
Wound Membrane, 2540 format
Operating Pressure (psi)—50-120

### Operating Temperature (° F.)—50-90

### Experimental Description

The membrane was loaded into the appropriate membrane housing on the filtration unit. Typical clean procedures were followed to ensure proper separation and flux during operation. Once the unit was prepared, about 10 gallons of reconstituted Concord Grape juice was added to the feed tank. This juice was recirculated under pressure to the membrane and back to the feed tank. Permeate was recycled to the feed tank until steady state was reached (about 10 minutes). After steady state had been reached, the permeate was collected in a separate vessel until about 5 gallons had been collected (about 50% of the starting volume). The resulting retentate was a juice containing about 80% increased color content versus the original feed juice. If the permeate were concentrated via evaporation and used to dilute the retentate, then the diluted retentate would be a juice of about 30-50% reduced sugar content (depending on degree of permeate concentration).

Feed juice, retentate and permeate streams were characterized analytically and the results presented in Tables 1-4, samples B1-B3.

TABLE 1
Process Parameters and Samples

| | | | Acid (g/100 g | |
|---|---|---|---|---|
| Sample | Sample ID | Brix | Tartaric) | pH |
| Feed Concord Juice 1K Da | A1 | 15.4 | 0.677 | 3.12 |
| Membrane | | | | |
| Retentate 1K Da Membrane | A2 | 17.6 | 0.747 | 3.09 |
| Permeate 1K Da Membrane | A3 | 7.0 | 0.390 | 3.28 |
| Feed Concord Juice 20K Da | B1 | 16.3 | 0.412 | 3.57 |
| Membrane | | | | |
| Retentate 20K Da Membrane | B2 | 19.0 | 0.488 | 3.54 |
| Permeate 20K Da Membrane | B3 | 13.6 | 0.336 | 3.62 |

TABLE 2
Color Analysis

| | Total | Methyl | Color | Color | |
|---|---|---|---|---|---|
| | Polyphenols | Anthranilate | (CA/g @ | (CA/g @ | Color Ratio |
| Sample ID | (% w/w) | (μg/L) | 520 nm) | 430 nm) | (520/430) |
| A1 | 0.20 | 322 | 5.52 | 4.03 | 1.37 |
| A2 | 0.23 | 301 | 6.79 | 5.02 | 1.35 |
| A3 | 0.01 | 109 | 0.08 | 0.1 | 0.80 |
| B1 | 0.30 | 610 | 10.54 | 6.07 | 1.74 |
| B2 | 0.60 | 550 | 21.39 | 13.18 | 1.62 |
| B3 | 0.05 | 317 | 0.26 | 0.27 | 0.96 |

TABLE 3
Acid Analysis

| Acid Type | | | | | | |
|---|---|---|---|---|---|---|
| (% w/w) | A1 | A2 | A3 | B1 | B2 | B3 |
| Fumaric Acid | <0.01 | <0.01 | <0.01 | <0.01 | <0.01 | <0.01 |
| Tartaric Acid | 0.14 | 0.15 | 0.07 | 0.13 | 0.14 | 0.12 |
| Malic Acid | 0.39 | 0.43 | 0.28 | 0.2 | 0.15 | 0.22 |
| Citric Acid | 0.02 | 0.02 | <0.01 | 0.02 | 0.02 | 0.01 |
| Butyric Acid | <0.01 | <0.01 | <0.01 | <0.01 | <0.01 | <0.01 |
| Acetic Acid | <0.01 | <0.01 | <0.01 | <0.01 | <0.01 | <0.01 |
| Lactic Acid | <0.01 | <0.01 | <0.01 | <0.01 | <0.01 | <0.01 |

TABLE 4
Sugar Content

| Sugar Type | | | | | | |
|---|---|---|---|---|---|---|
| (% w/w) | A1 | A2 | A3 | B1 | B2 | B3 |
| Fructose | 7 | 8 | 3.31 | 7.29 | 8.13 | 6.55 |
| Glucose | 5.83 | 6.93 | 2.61 | 6.28 | 7.18 | 5.57 |
| Sucrose | <0.25 | <0.25 | <0.25 | <0.25 | <0.25 | <0.25 |
| Maltose | <0.25 | <0.25 | <0.25 | <0.25 | <0.25 | <0.25 |
| Lactose | <0.25 | <0.25 | <0.25 | <0.25 | <0.25 | <0.25 |

### Example 5—Method for Determining Color

1.) Product to be measured is weighed into an appropriately sized volumetric flask (e.g., 5 grams of product into a 50 mL volumetric flask).
2.) Product is brought to volume with 3.2 pH buffer (McIlvaine's Buffer.)
3.) Diluted product is then filtered through a 25 mm Type A/E glass fiber filter circle.
4.) Filtered product is then measured for absorbance at a specific wavelength (e.g. 520 nm and 430 nm.)
5.) Absorbance must be between 0.3 and 0.7. If absorbance is not met, then initial quantity diluted must be adjusted.
6.) Cuvette must have a width of 1 cm.
   The following calculation is used for CA/g:

$$\frac{Abso r bance of Diluted Sample * Volume of Dilution Flask in mL}{Initial Mass of Product in Grams}$$

EX:(0.5 Abs*50 mL)/5 g=5 CA/g@520 nm

If product falls below 0.7 Abs without dilution, then color is reported on the product without dilution. Product is still filtered regardless of dilution. Units are still reported as Corrected Absorbance per gram (CA/g).

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method for producing a reduced sugar fruit juice, vegetable juice or combination thereof, comprising:
a) filtering a feed juice comprising fruit juice, vegetable juice or combination thereof through an ultrafiltration membrane to produce permeate juice having lower color and sugar content compared to the feed juice, and retentate juice having a color and sugar content being higher than the feed juice;
b) concentrating the permeate juice in an evaporator to produce a concentrated permeate juice fraction and a fraction comprising water and essence, or concentrating the retentate juice in an evaporator to produce a concentrated retentate juice fraction and a fraction comprising water and essence; and
c) adding the water and essence fraction to the retentate juice or the permeate juice that has not been concentrated in b) in an amount sufficient to produce a fruit juice or vegetable juice having a reduced sugar content compared to the sugar content of the feed juice and having flavor notes that are characteristic of the feed juice before ultrafiltration.

2. The method of claim 1, wherein the juice is from grapes, apple, cranberry or pomegranate.

3. The method of claim 2, wherein the grapes are Concord grapes or Niagara grapes.

4. The method of claim 3, wherein the sugar content is reduced to about 7° Brix to about 10° Brix for Concord juice, about 5° Brix to about 7° Brix for apple juice, from about 3° Brix to about 4° Brix for cranberry juice, from about 7° Brix to about 9° Brix for pomegranate juice, compared to the sugar content of fruit juice or vegetable juice before ultrafiltration.

5. The method of claim 1, wherein the sugar content is reduced to from about 35% to about 70%.

6. The method of claim 1, wherein at least a portion of the retentate juice is recycled back through the ultrafiltration membrane.

7. The method of claim 1, wherein the filtering is performed for a period of time sufficient to create a volume of permeate having at least 50% of the sugars from the feed juice.

8. The method of claim 1, wherein the filtering is performed as a continuous method.

9. The method of claim 1, wherein the filtering is performed as a batch method.

10. A reduced sugar fruit juice, vegetable juice or combination thereof produced by the method of claim 1.

11. A concentrated juice produced by the method of claim 1 having the water and essence removed therefrom and having a sugar content of from about 45 Brix to about 68 Brix.

12. A reduced sugar fruit juice, vegetable juice or combination thereof, comprising a reduced sugar content of from about 35% to about 70% of its naturally occurring sugar content, and retains some of the color and flavor, anthocyanins and polyphenol content of the naturally occurring color, flavor, anthocyanins and polyphenol content.

13. The reduced sugar fruit juice, vegetable juice or combination thereof of claim 12, wherein the juice is from grapes, apple, cranberry or pomegranate.

14. The reduced sugar fruit juice, vegetable juice or combination thereof of claim 13, wherein the grapes are Concord grapes or Niagara grapes.

15. A method for producing a reduced sugar fruit juice or vegetable juice, comprising:
filtering a feed juice comprising fruit juice, vegetable juice or combination thereof through an ultrafiltration membrane to produce permeate juice fraction having lower color and reduced sugar content compared to the feed juice, and a retentate juice fraction having a color and sugar content being higher than the feed juice; and
adding water and optional fruit juice or vegetable juice essence from the same or different fruit or vegetable source to the retentate juice fraction in an amount sufficient to produce a fruit juice or vegetable juice having a reduced sugar content compared to the sugar content of the feed juice and having flavor notes that are characteristic of the feed juice before ultrafiltration and flavor notes from the optional essence if added,
thereby producing a reduced sugar juice from the permeate fraction and a reduced sugar juice from the retentate fraction.

16. A reduced sugar fruit juice, vegetable juice or combination thereof produced by the process of claim 15.

17. An ultrafiltered juice having up to a 70% reduction in sugar content compared to an unfiltered counterpart juice, a reduced color compared to the unfiltered counterpart juice, flavor notes that are characteristic of the unfiltered counterpart juice, and potassium and calcium levels similar to the unfiltered counterpart juice.

18. The ultrafiltered juice of claim 17, wherein the juice is from grapes, apple, cranberry, or pomegranate.

19. The ultrafiltered juice of claim 18, wherein the sugar content is reduced to about 7° Brix to about 10° Brix for Concord juice, about 5° Brix to about 7° Brix for apple juice, from about 3° Brix to about 4° Brix for cranberry juice, from about 7° Brix to about 9° Brix for pomegranate juice, compared to the sugar content of the full-strength fruit juice or vegetable juice.

20. The ultrafiltered juice of claim 17, wherein the sugar content is reduced to from about 40% to about 60%.

21. The ultrafiltered juice of claim 17, wherein the juice has been filtered through a membrane having a MWCO of from about 600 Da to about 5,000 Da.

22. An ultrafiltered juice having up to a 70% reduction in sugar content compared to an unfiltered counterpart juice, and at least a 15% reduction in each of color and total percent by weight polyphenols content, such that the ultrafiltered juice resembles the unfiltered juice in appearance.

23. The ultrafiltered juice of claim 22, wherein the juice is from grapes, apple, cranberry, or pomegranate.

24. The method of claim 1, further comprising adding essence from a different fruit or vegetable.
